(19) United States
(12) Patent Application Publication
(10) Pub. No.: US 2026/0333270 A1
(43) Pub. Date: Oct. 22, 2026

(54) NETWORK REPOSITORY HIERARCHY

(71) Applicant: Telefonaktiebolaget LM Ericsson (publ), Stockholm (SE)

(72) Inventors: Emiliano MERINO VAZQUEZ, Madrid (ES); Maria Cruz BARTOLOME RODRIGO, Madrid (ES)

(21) Appl. No.: 19/105,877

(22) PCT Filed: Nov. 21, 2022
(86) PCT No.: PCT/EP2022/082605

§ 371 Date: Feb. 24, 2025

(30) Foreign Application Priority Data
Sep. 2, 2022 (EP) 22382822.9

(51) Int. Cl. H04W 60/00

(52) U.S. Cl. CPC H04W 60/00

(57) ABSTRACT

Embodiments can relate to various methods for operating a network entities in a wireless communications network. The wireless communications network includes a function provider entity and at least one function consumer entity, capable of consuming services from the function provider entity, wherein the function provider entity includes a plurality of instances deployed as a set across a plurality of network repository entities having lower and higher hierarchy levels. The methods include various steps for identifying the plurality of instances through communication across the plurality of network repository entities having lower and higher hierarchy levels. Further embodiments relate to various corresponding devices.

### TECHNICAL FIELD

The present invention relates to various methods and devices for allowing a wireless communications network to implement a network repository hierarchy which enables a given network repository to obtain knowledge of multiple instances of a given set of network function.

### BACKGROUND

FIG. 1 shows a 5G NR architecture with service based interfaces. The 5G core network part comprises a Network Slice Selection Function, NSSF 10, a Network Exposure Function 11, a Network Repository Function, NRF, 12, a Policy Control Function, PCF, 13, a Unified Data Management, UDM, 14, an Application Function, AF, 15, an Authentication Server Function, AUSF, 16, an Access and Mobility Management Function, AMF, 17, and a Session Management Function, SMF, 18. A User Equipment, UE, 1, is connected to the Radio Access Network, RAN, 19, wherein a User Plane Function, UPF, 20 is provided to connect the UE 1 to a data network, DN, 21.

Having service based interfaces in the 5G Core Control Plane (CP) implies that the Network Functions, NFs, in the 5G Core CP provide services that are consumed by other NFs in the 5G Core CP.

The roles of these entities and the interfaces have been defined in the 3GPP TS 23.181 and the procedures have been described in TS 23.182.

The most relevant 5G System Architecture network functions for this invention are the following:
AF 15 interacts with the 3GPP Core Network so as to provide information that will allow network operator to manage application's traffic in a certain way;
NEF 11 is the entry point for ASPs (Application Service Providers) to the Mobile Network Operator Network a.k.a. Connectivity Service Provider (CSP). NEF 11 exposes the Connectivity Service Provider Mobile Network capabilities to the ASPs and translates between information as known by the external Application Functions (AFs) and information as known by the Mobile Network Function/s;
NRF 12 maintains an updated repository of all the elements available in the operator's network along with the services provided by each of the elements. NRF 12 supports discovery mechanisms that allows elements to discover each other and get updated status of the desired elements;
PCF 13 supports unified policy framework to govern the network behaviour. In particular, PCF 13 provides Policy and Charging Control, PCC, rules to the Policy and Charging Enforcement Function, PCEF, that is, SMF 18/UPF 20 that enforces policy and charging decisions according to provisioned PCC rules;
SMF 18 is responsible for Session establishment, modification and release, including selection and control of the UPF 20 entities. SMF 18 interacts with the UPF 20 over N4 Reference point using PFCP (Packet Flow Central Protocol) procedures. Moreover, SMF 18 receives PCC rules from PCF 13 and configures the UPF 20 accordingly;
UPF 20 supports handling of user plane traffic based on the rules received from SMF, in particular packet inspection and different enforcement actions (QOS, Charging, etc.)

In 5G networks there might be configurations in which a plurality of NRFs 12 are present, such as schematically illustrated in FIG. 2, where three NRFs are present, namely NRF-1, NRF-2 and NRF-3. In such cases, not all NRFs might be aware of all other NRFs. There might be cases, in which one or more NRF is aware of the other NRF instances, but the remaining NRFs are not. In the example of FIG. 2, it will be assumed that NRF-2 is aware of both NRF-1 and NRF-3, while NRF-1 is only aware of NRF-2.

In such configurations, it is further possible that some network functions might be registered only with one NRF. For instance, in FIG. 2, it is possible that NRF-3 has knowledge of a specific network function NFx because network function NFx has registered with NRF-3.

To allow discovery of NFx by Network Functions registered in other NRFs, such as NRF-1, 3GPP currently allows two approaches, schematically illustrated in FIGS. 3 and 4.

In general, Network function consumer—in the following, NFc—only knows its own/local/regional NRF. The NFc therefore sends the NRF requests to its local/regional NRF. However, some operations may need to reach another NRF, in a higher level or hierarchy. That is, a local NRF, for instance NRF-1, can behave as an intermediate NRF in order to reach other NRFs, such as NRF-2, or NRF-3, in order to access to required information or Network Function NFx.

This is possible in 3GPP Rel-17 (3GPP TS 29.510 v17.5.0 5G System; Network function repository services; Stage 3) only for the following operations:
Nnrf_NFDiscovery_NFDiscover (5.3.2.2.4, 5.3.2.2.5)
Nnrf_NFManagement_NFStatusSubscribe (5.2.2.5.4, 5.2.2.5.5)
Nnrf_AccessToken_Get (5.4.2.2.2, 5.4.2.2.3)

The intermediate NRF, for instance NRF-1, may either redirect or forward the request to the other NRFs, such as NRF-2 or NRF-3. The information on which other NRF is to be the destination of the redirection or forwarding is expected to be configured in the local, or intermediate, NRF, such as NRF-1. In some cases, this information can be provided by the other NRFs registering with the local, or intermediate, NRF.

In particular, in FIG. 3, NRF-1 acts as local NRF and receives a discovery request for network function NFx. Since NRF-1 cannot answer this request, it forwards the request to the other NRF which NRF-1 is aware of, namely NRF-2. This is illustrated by the message GET-1. NRF-2 also cannot answer this discovery request directly, but NRF-2 is aware of the existence of NRF-3, so it further forwards the request to NRF-3, as illustrated by the message GET-2. At this point the discovery request can be answered by NRF-3 through message ANS-2 to NRF-2, which is then forwarded to NRF-1 as message ANS-3. Optionally, NRF-2 can also negatively answer the request GET-1 through a message ANS-1, as illustrated.

The situation illustrated in FIG. 3 is referred to as service discovery with intermediate forwarding 1. NRF-1 receives a service discovery request and sends the service discovery request to a pre-configured NRF-2. This may for example include cases where NRF-1 does not have sufficient information as determined by the operator policy to fulfil the request locally. Upon receiving a service discovery request, based on the information contained in the service discovery request (e.g. the “supi” query parameter in the URI) and locally stored information, NRF-2 identifies the next hop NRF (see clause 5.2.2.2.3 in 3GPP Rel-17), and forward the service discovery request to that NRF, such as NRF-3 in this example. FIG. 5.3.2.2.2-1 of 3GPP Rel-17 further discloses the forwarding by NRF-2, where the originator of the service invocation is NRF-2 and the recipient of the service invocation is NRF-3. The locally stored information in NRF-1 and/or NRF-2 may be preconfigured, or registered by other NRFs (see clause 5.2.2.2.3 in 3GPP Rel-17).

In the alternative implementation of FIG. 4, NRF-1 similarly receives a discovery request for network function NFx. Again, since NRF-1 cannot answer this request, it forwards the request to the other NRF which MRF-1 is aware of, namely NRF-2, as illustrated by the message GET-1. As before, NRF-2 also cannot answer this discovery request, so it negatively answer the request GET-1 through a message ANS-1, as illustrated. However, since NRF-2 is aware of NRF-3, the message ANS-1 can comprise data identifying NRF-3 as the next NRF hop, so that NRF-1 can then repeat the request to NRF-3, having now become aware of its existence, as illustrated by the message GET-2. At this point the discovery request can be answered by NRF-3 through message ANS-2 to NRF-1 directly.

The approach illustrated in FIG. 4 is referred to as service discovery with intermediate redirecting. In this case, NRF-1 receives a service discovery request but does not have the information to fulfil the request. Then NRF-1 sends the service discovery request to a pre-configured NRF-2. Upon receiving a service discovery request, based on the information contained in the service discovery request (e.g. the “supi” query parameter in the URI) and locally stored information NRF-2 shall identify the next hop NRF (see clause 5.2.2.2.3 in 3GPP Rel-17), and redirect the service discovery request by returning HTTP 147 Temporary Redirect response. The locally stored information in NRF-2 may, as previously, be preconfigured or registered by other NRFs (see clause 5.2.2.2.3 in 3GPP Rel-17). The 147 Temporary Redirect response shall contain a Location header field, the host part of the URI in the Location header field represents NRF-3.

One problem which arises with the implementation above is that the local NRF, for instance NRF1, receiving the request, should forward, or redirect, it to the next NRF if the local NRF does not have “enough” or “sufficient” information to fulfil the request. 3GPP Rel-17 does not clarify when a NRF has, or does not have, such “enough” or “sufficient” information to fulfil the request.

This can lead to issues, for instance, in configurations in which the Network Function NFx is not registered as a single instance in a single NRF.

FIG. 5 schematically illustrates a configuration in which the a given Network Function has a plurality of producers NFp, such as NFpA and NFpB, for the same function NFp. Here, as illustrated, it is possible that a local NRF, such as NRF-1, is registering NFpA, while NFpB is registered in another NRF, such as NRF-2.

In this case, when a consumer function, NFc, also located in the local NRF, here NRF-1, sends a discovery request, this reaches the local NRF, NRF-1 in this example. Since this request can be answered directly. NRF-1 does not need to carry out any further forwarding, so that NFc can only discover NFpA but not NFpB.

This also applies even if NFpB registered itself with a NRF with a higher hierarchy than NRF-2.

For instance, FIG. 6 schematically illustrates a configuration similar to FIG. 5, wherein a further NRF-3 is present, which acts as a NRF with higher hierarchy than NRF-1 and NRF-2.

In this case, as illustrated in FIG. 7, each instance of registers to its local NRF, namely NPpA registers with NRF-1, and NFpB with NRF-2, providing the information required in the NF profile. It is highlighted that, while each NFp may be assigned a different locality, both can belong to the same set.

Additionally, each local/regional NRF registers to a higher NRF in the hierarchy. In this example this is NRF-3. In this registration, the local/regional NRF provides the “nrfInfo” field that includes part of the information provided in the NF profile. That is, regional NRF registers only the routing information, such as SUPI ranges served, of the NF profile in the higher hierarchical NRF, so that the higher NRF knows how to find the NF profile of an NFp registered in any regional NRF. This routing information does not need to include the Locality nor the NF service set, as well as many other NF profile data not part of the routing information.

When a NFc in the NRF-1 region, such as NFcA, requests to its local/regional NRF a discovery, since the local/regional NRF-1 is able to find at least one NFp profile answering the discovery request, here NFpA, then it may simply provide this result to the consumer. In this case, just part of the NFp set is provided to the consumer. If the provided NFpA fails, or is not accessible for any reason, then request by the consumer will therefore fail, since for the NFc it is unknown that in fact there are other instances in the set that may be available. Then, NFp set redundancy is not usable by the NFc.

Another issue may occur even if multiple NFp profiles are provided, in case there is a geographical failure. For instance, as illustrated in FIGS. 8 and 9, NFpA and NFpB are deployed in a first geographic area, for instance Geo-AreaA, while NFpC is deployed in different geographic area, such as Geo-AreaB. All three NFps belongs to the same set. This is a very common deployment to provide geo redundancy with a set deployment. While the NFp set is deployed in two NRF regions, a third NRF region may be deployed as a higher level in the NRF hierarchy. In the example this is NRF-3.

As previously described each NFp registers to its local/regional NRF, providing the information required in the NF profile. It is highlighted that each NFp may be assigned a different locality, but they belong to the same set. Also, as previously described, each local NRF registers to a higher NRF in the hierarchy, in this example is the NRF-3. In this registration, the local NRF provides “nrfInfo” that includes part of the information provided in the NF profile. It does not need to include the locality nor the NF service set.

An NFc in NRF-1 region, such as NFcA, requests to its local/regional NRF a discovery. Since the NRF-1 is able to find at least one NFp profile, here any of NFpA or NFpB, then it may simply provide this result to the consumer. Then, just part of the NFp set is provided.

A geographical disaster may cause NFpA and NFpB to become unreachable, or may fail. If the selected NFpA fails or is not accessible for any reason, then the request will fail. In this example, there is another NFpB that can be provided in the discovery, but this has equally failed. It is noted that the NFc may know already by health supervision mechanisms, local or from NRF, that NFpA and NFpB are down, so the illustrated requests may not even be sent.

Then, the conclusion is that even if NFps are deployed to provide geo-redundancy, this is not usable by the NFc. The current NRF hierarchy mechanism causes as well a wrong load-balancing in the system, as long as for each NFc only the local registered NFp instances in a set are known.

While the examples provided above are focused on a discovery request, the same issue arise for other NRFs' operations that may require to reach other NRFs in the hierarchy, for instance the subscription and AccessToken, as indicated above.

### SUMMARY

There is therefore a need to provide a NRF hierarchy which overcomes the issues described above. This need is met by the features of the independent claims. Further aspects are described in the dependent claims.

An embodiment of the invention can in particular relate to a method for operating a network repository entity in a wireless communications network, the wireless communications network comprising a function provider entity and at least one function consumer entity, capable of consuming services from the function provider entity. In particular, the function provider entity can comprise a plurality of instances deployed as a set across a plurality of network repository entities having lower and higher hierarchy levels. The method for operating the network repository entity can comprise a step of receiving, from at least one of the plurality of instances, a registration request comprising an identification of the set. The registration request further comprises an indication that the function provider entity comprises a plurality of instances deployed as a set across the plurality of network repository entities. The method can further comprise a step of transmitting to a second network repository entity with a higher hierarchy level, a second registration request comprising the identification of the set.

In some embodiments, the plurality of network repository entities can comprise at least two network repository entities with a lower hierarchy level, and at least the second network repository entity. The network repository entity belongs to the at least two network repository entities with the lower hierarchy level. On the other hand, the second network repository entity can have a higher hierarchy level than the at least two network repository entities and can be common to the at least two network repository entities.

In some embodiments, at least a second instance of the plurality of instances can be configured to be registered in one of the network repository entities with the lower hierarchy level other than the network repository entity.

A further embodiment of the invention can relate to a method for operating a network repository entity in a wireless communications network, the wireless communications network comprising a function provider entity and at least one function consumer entity, capable of consuming services from the function provider entity. In particular, the function provider entity can comprise a plurality of instances deployed as a set across a plurality of network repository entities having lower and higher hierarchy levels. The method for operating the network repository entity can comprise a step of receiving, from the function consumer entity, a discovery request for the function provider entity. The method can further comprise a step of recognizing that the function provider entity comprises the plurality of instances deployed as a set across the plurality of network repository entities having lower and higher hierarchy levels. In particular, the set can be identified by an identification. The method can further comprise a step of transmitting, to a second network repository entity, a second discovery request for the function provider entity, the second discovery request comprising the identification of the set.

In some embodiments, the plurality of network repository entities can comprise at least two network repository entities with a lower hierarchy level, and at least the second network repository entity. The network repository entity can belong to the at least two network repository entities with the lower hierarchy level. On the other hand, the second network repository entity can have a higher hierarchy level than the at least two network repository entities, and can be common to the at least two network repository entities.

In some embodiments, the method can further comprise a step of receiving, from the second network repository entity, a discovery response comprising a profile of the one or more instances not registered with the network repository entity but registered with at least another one of the plurality of network repository entities.

In some embodiments, the method can further comprise a step of transmitting, to the function consumer entity, a second discovery response comprising a profile of the one or more instances not registered with the network repository entity but registered with at least another one of the plurality of network repository entities. Moreover the second discovery response can further comprise the one or more instances registered with the network repository entity.

In some embodiments, the step of recognizing can comprise a step of identifying at least one of the plurality of instances registered with the network repository entity. The step of recognizing can further comprise a step of retrieving the identification of the set based on the at least one instance identified at the identifying step.

A further embodiment of the invention can relate to a method for operating an instance of a function provider entity in a wireless communications network, the wireless communications network comprising the function provider entity and at least one function consumer entity, capable of consuming services from the function provider entity. In particular, the function provider entity can comprise a plurality of instances deployed as a set across a plurality of network repository entities having lower and higher hierarchy levels. The method for operating the instance of the function provider entity can comprise a step of transmitting, to the network repository entity, a registration request comprising an identification of the set and an indication that the function provider entity comprises a plurality of instances deployed as a set across the plurality of network repository entities having lower and higher hierarchy levels.

A further embodiment of the invention can relate to a method for operating a network repository entity in a wireless communications network, the wireless communications network comprising a function provider entity and at least one function consumer entity, capable of consuming services from the function provider entity. In particular, the function provider entity can comprise a plurality of instances deployed as a set across a plurality of network repository entities having lower and higher hierarchy levels. The method for operating the network repository entity can comprise a step of receiving, from a second network repository entity, a registration request comprising the identification of the set. The method can further comprise a step of storing routing information of the at least one of the plurality of instances in correspondence with the identification of the set.

A further embodiment of the invention can relate to a method for operating a network repository entity in a wireless communications network, the wireless communications network comprising a function provider entity and at least one function consumer entity, capable of consuming services from the function provider entity. In particular, the function provider entity can comprise a plurality of instances deployed as a set across a plurality of network repository entities having lower and higher hierarchy levels. The method for operating the network repository entity can comprise a step of receiving, from a second network repository entity, a discovery request for the function provider entity comprising an identification of the set. The method can further comprise a step of transmitting, to the second network repository entity, a discovery response. The discovery response can comprise a profile of the one or more instances not registered with the second network repository entity.

In some embodiments, the plurality of network repository entities can comprise at least two network repository entities with a lower hierarchy level, and at least the network repository entity. The second network repository entity can belong to the at least two network repository entities with the lower hierarchy level. The network repository entity can have a higher hierarchy level than the at least two network repository entities and can be common to the at least two network repository entities.

In some embodiments, the method can further comprise the step of transmitting, to one or more third network repository entity, a second discovery request comprising the identification of the set. Moreover, the method can further comprise a step of receiving, from the one or more third network repository entity, a discovery response comprising a profile of the one or more instances registered with the one or more third network repository entity.

In some embodiments, the one or more third network repository entity comprise all network repository entities with a lower hierarchy level than the network repository entity.

In some embodiments, each of the one or more third network repository entity can be a local and/or regional network repository entity.

In some embodiments, the one or more third network repository entity can comprise all network repository entities with a lower hierarchy level than the network repository entity, except for the second network repository entity.

In some embodiments, the method can further comprise the step of identifying, based on the identification of the set, the one or more third network repository entity at which the at least one of the plurality of instances of the set not registered with the second network repository entity is registered.

In some embodiments, the method can further comprise the step of transmitting, to the second network repository entity, a second discovery response comprising a profile of the one or more instances identified with the identifying step.

A further embodiment of the invention can relate to a network repository entity operable in a wireless communications network, the wireless communications network comprising a function provider entity and at least one function consumer entity, capable of consuming services from the function provider entity. In particular, the function provider entity can comprise a plurality of instances deployed as a set across a plurality of network repository entities having lower and higher hierarchy levels. The network repository entity can comprise a processing unit, and a memory. The memory can comprise instructions configured to cause the processing unit to carry out a method. In particular, the method can comprise a step of receiving, from at least one of the plurality of instances, a registration request comprising an identification of the set and an indication that the function provider entity comprises a plurality of instances deployed as a set across the plurality of network repository entities having lower and higher hierarchy levels. The method can further comprise a step of transmitting, to a second network repository entity with a higher hierarchy level, a second registration request comprising the identification of the set.

In some embodiments, the memory of the the network repository entity can further comprise instructions configured to cause the processing unit to further carry out any of the steps according to any of the methods related to the network repository entity.

A further embodiments of the invention can relate to a network repository entity operable in a wireless communications network, the wireless communications network comprising a function provider entity and at least one function consumer entity, capable of consuming services from the function provider entity. In particular, the function provider entity can comprise a plurality of instances deployed as a set across a plurality of network repository entities having lower and higher hierarchy levels. The network repository entity can comprise a processing unit, and a memory. The memory can comprise instructions configured to cause the processing unit to carry out a method. In particular, the method can comprise a step of receiving, from the function consumer entity, a discovery request for the function provider entity. The method can further comprise a step of recognizing that the function provider entity comprises the plurality of instances deployed as a set across the plurality of network repository entities having lower and higher hierarchy levels, and that the set is identified by an identification. Moreover, the method can comprise a step of transmitting, to a second network repository entity, a second discovery request for the function provider entity, the second discovery request can comprise the identification of the set.

In some embodiments, the memory of the the network repository entity can further comprise instructions configured to cause the processing unit to further carry out any of the steps according to any of the methods related to the network repository entity.

A further embodiments of the invention can relate to an instance of a function provider entity operable in a wireless communications network, the wireless communications network comprising the function provider entity and at least one function consumer entity, capable of consuming services from the function provider entity. In particular, the function provider entity can comprise a plurality of instances deployed as a set across a plurality of network repository entities having lower and higher hierarchy levels. The instance can comprise a processing unit, and a memory. The memory can comprise instructions configured to cause the processing unit to carry out a method. The method can comprise a step of transmitting, to the network repository entity, a registration request comprising an identification of the set and an indication that the function provider entity comprises a plurality of instances deployed as a set across the plurality of network repository entities having lower and higher hierarchy levels.

A further embodiments of the invention can relate to network repository entity operable in a wireless communications network, the wireless communications network comprising a function provider entity and at least one function consumer entity, capable of consuming services from the function provider entity. In particular, the function provider entity can comprise a plurality of instances deployed as a set across a plurality of network repository entities having lower and higher hierarchy levels. The network repository entity can comprise a processing unit, and a memory. The memory can comprise instructions configured to cause the processing unit to carry out a method comprising a step of receiving, from a second network repository entity, a registration request comprising the identification of the set. The method can further comprise a step of storing routing information of the at least one of the plurality of instances in correspondence with the identification of the set.

A further embodiments of the invention can relate to a network repository entity operable in a wireless communications network, the wireless communications network comprising a function provider entity and at least one function consumer entity, capable of consuming services from the function provider entity. In particular, the function provider entity can comprise a plurality of instances deployed as a set across a plurality of network repository entities having lower and higher hierarchy levels. The network repository entity can comprise a processing unit, and a memory. The memory can comprise instructions configured to cause the processing unit to carry out a method comprising a step of receiving, from a second network repository entity, a discovery request for the function provider entity comprising an identification of the set. The method can further comprise a step of transmitting, to the second network repository entity, a discovery response. The discovery response can comprise a profile of the one or more instances not registered with the second network repository entity.

In some embodiments, the memory of the the network repository entity can further comprise instructions configured to cause the processing unit to further carry out any of the steps according to any of the methods related to the network repository entity.

### BRIEF DESCRIPTION OF DRAWINGS

Various features of embodiments will become more apparent when read in conjunction with the accompanying drawings. In these drawings:

FIG. 1 schematically illustrates the 5G NR reference architecture as defined by 3GPP;

FIG. 2 schematically illustrates a network configuration in which a network function is accessible by a plurality of network repository entities according to the prior art;

FIGS. 3 and 4 schematically illustrates method steps for forwarding a discovery request for a network function across a plurality of network repository entities according to the prior art;

FIGS. 5, 6 and 8 schematically illustrates network configurations in which a function provider entity comprises a plurality of instances deployed as a set across a plurality of network repository entities according to the prior art;

FIGS. 7 and 9 schematically illustrates potential issues in accessing instances of a function provider entity deployed as a set across a plurality of network repository entities according to the prior art;

FIGS. 10A and 10B schematically illustrate a method for accessing instances of a function provider entity deployed as a set across a plurality of network repository entities having lower and higher hierarchy levels according to an embodiment of the invention,

FIGS. 11 to 15 schematically illustrate methods for operating various network entities according to embodiments of the invention,

FIGS. 16 to 18 schematically illustrate various network entities according to embodiments of the invention.

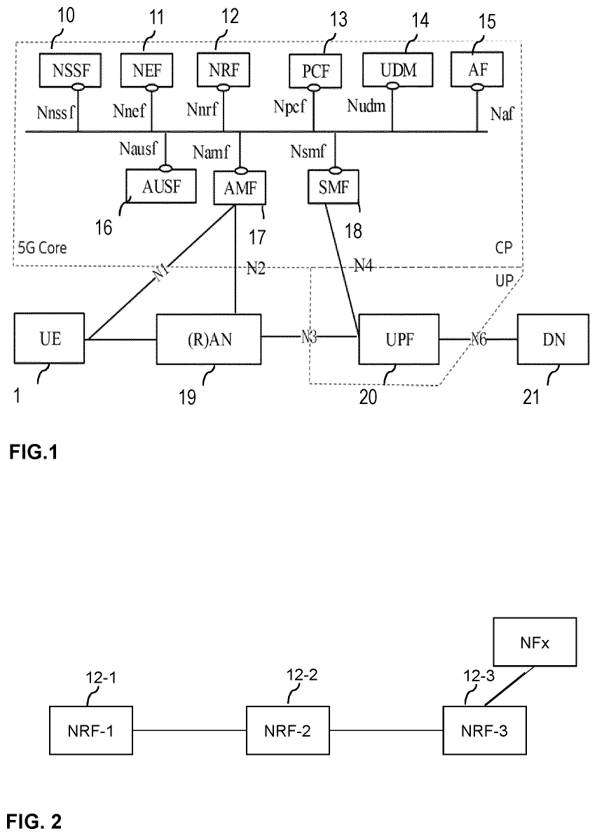

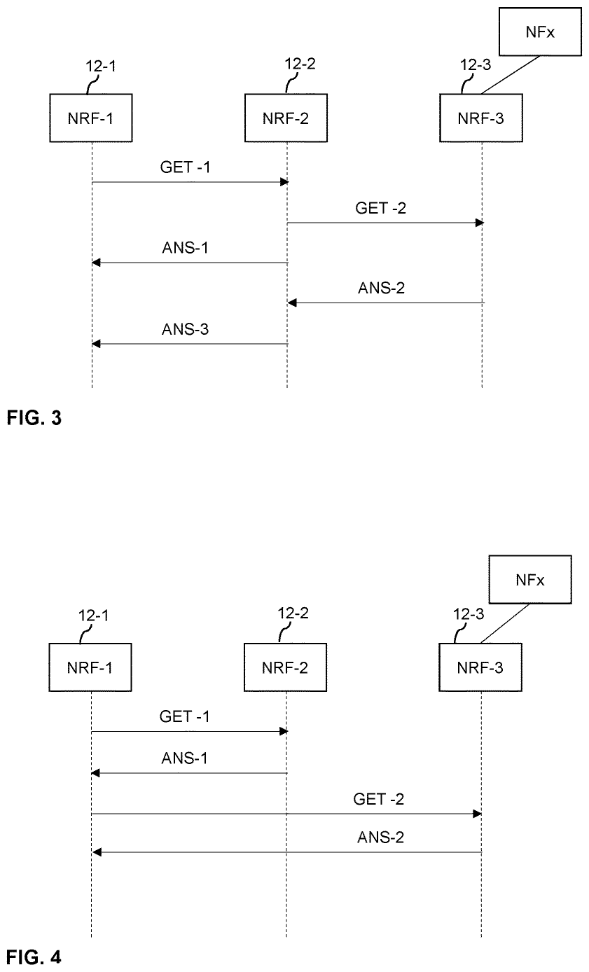

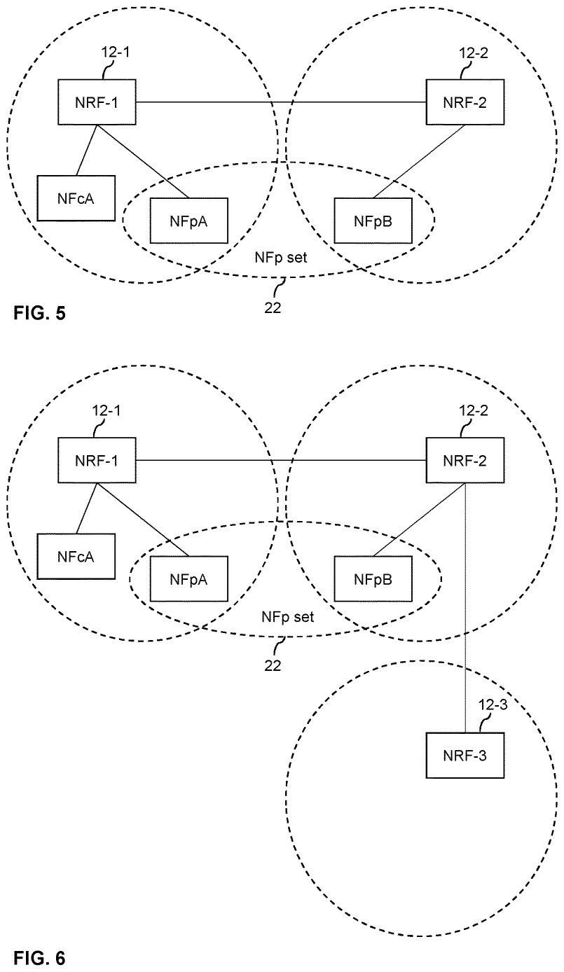

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

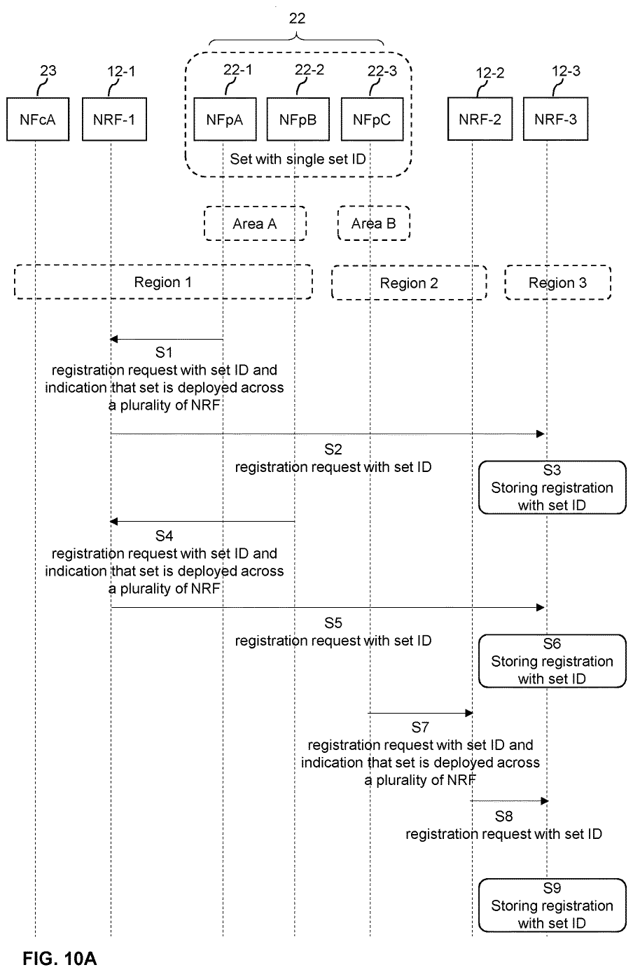

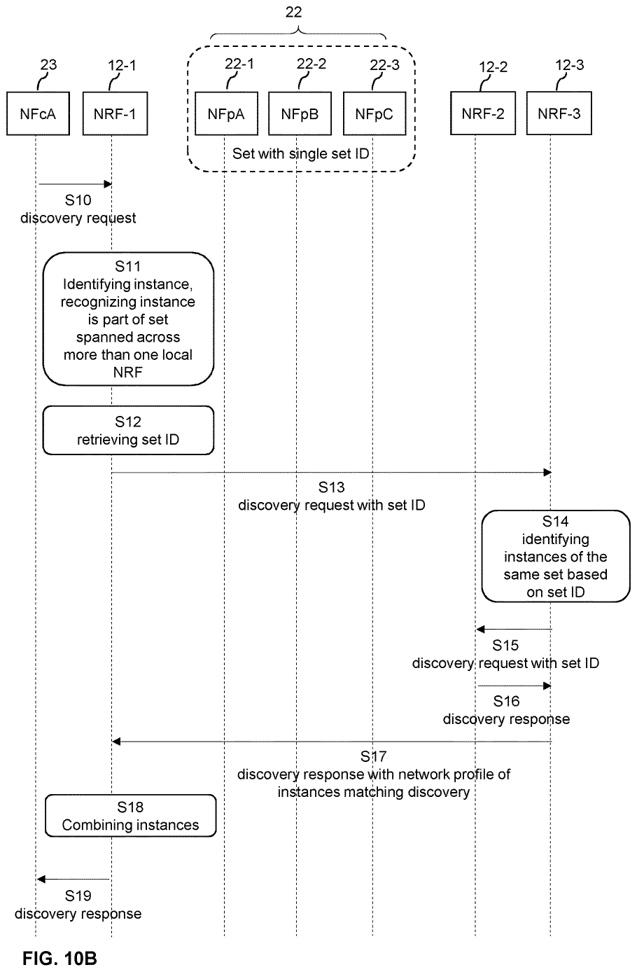

Various embodiments will be described with reference to FIGS. 10A and 10B. It is noted that FIGS. 10A and 10B comprise a plurality of steps, not all of which are necessary for implementing the invention but which have been included for clarity of explanation. A general description will therefore first be first given of all steps comprised in FIGS. 10A and 10B for a better understanding of the various embodiments will be described in the following.

FIGS. 10A and 10B generally describe for a wireless communications network comprising a function provider entity 22 and at least one function consumer entity 23, NFcA, capable of consuming services from the function provider entity 22.

The function provider entity 22 comprises a plurality of instances deployed as a set across a plurality of network repository entities having lower and higher hierarchy levels. In the example illustrated in FIG. 10A, the function provider entity 22 comprises three instances NFpA, NFpB and NFpC, indicated by reference numerals 22-1 to 22-3. It will be clear to those skilled in the art that any number of instances can be implemented. The instances belong to a set, which is associated to a set ID, or an identification of the set.

In the specific embodiment illustrated in FIG. 10A, the wireless communications network comprises three regions, corresponding to three respective network repository entities NRF-1, NRF-2 and NRF-3, indicated by reference numerals 12-1 to 12-3. Also in this case, it will be clear to those skilled in the art that any number of network repository entities can be implemented.

The network repository entities 12-1 to 12-3 operate in a hierarchical manner. That is, at least one of the network repository entities 12-1 to 12-3 has a higher hierarchical level and at least a different one of the network repository entities 12-1 to 12-3, preferably at least two, has a lower hierarchical level.

In the example illustrated in FIG. 10 A, the network repository entities 12-1 and 12-2 have a lower hierarchical level and the network repository entity 12-3 has a higher hierarchical level. Preferably, the network repository entity 12-3, with the higher hierarchical level, is common to a plurality, preferably all, of the network repository entities 12-1 and 12-2 with a lower hierarchical level. In some embodiments, the one or more network repository entities with a lower hierarchical level can correspond to local and/or regional network repository entities. Alternatively, or in addition, the one or more network repository entities with a higher hierarchical level can also correspond to local and/or regional network repository entities. The one or more network repository entities with a higher hierarchical level can operate to store information concerning registration at network repository entities with a lower hierarchical level. In some embodiments, they can also store profiles for local NFps.

The instances being deployed as a set across the plurality of network repository entities having lower and higher hierarchy levels can be understood as comprising at least two instance. Of those at least two instances, at least one instance, such as 22-1, can be registered with a first network repository entity, such as 12-1, and at least one further instance, such as 22-2, can be registered with a second network repository entity, such as 12-2. Both the first and second network repository entity 12-1 and 12-2 have a lower hierarchical level. Further, both the first and second network repository entity 12-1 and 12-2 share a common network repository entity with a higher hierarchical level, such as 12-3.

As will become clear from the following description, network repository entities with lower hierarchical level are configured to inform the one or more network repository entity with higher hierarchical level about instances of the function provider entity 22 which are register with them. In this manner, the network repository entity with the higher hierarchical level can gather knowledge of where, in the wireless communications network, the instances of the function provider entity 22 are registered. This advantageously allows, as will become clear from the following description, the network repository entity with the higher hierarchical level to provide such information in response to a discovery request.

In the exemplary embodiment illustrated in FIG. 10A, a first region of the wireless communications network, indicated as region 1, uses the network repository entity NRF-1, indicated by reference numeral 12-1. Similarly, a second region of the wireless communications network, indicated as region 2, uses the network repository entity NRF-2, indicated by reference numeral 12-2. Finally, a second region of the wireless communications network, indicated as region 3, uses the network repository entity NRF-3, indicated by reference numeral 12-3.

Moreover, differential geographical areas can be defined within the wireless communications network. In the exemplary embodiment illustrated in FIG. 10A, a first area of the wireless communications network, indicated as area A, uses the network repository entity NRF-1, indicated by reference numeral 12-1, while a second area, indicated as area B, uses the network repository entity NRF-2, indicated by reference numeral 12-2.

One or more instances of the function provider entity 22 can be registered in any given area or region. In the exemplary embodiment illustrated in FIG. 10 A, instances 22-1 and 22-2 are both registered in area A and in region 1, while instance 22-3 is registered in area B and in region 2. For ease of description, no instances have indicated as being registered in region 3, corresponding to the network repository entity 12-3 having a higher hierarchical level. It will nevertheless be clear to those skilled in the art is that it is possible to also register one or more instances with the network repository entity having a higher hierarchical level. In this case, the network repository entity with the higher hierarchical level can also implement functionalities which will be described in the following with reference to the network repository entities with a lower hierarchical level.

Generally, at steps S1-S3, one instance 22-1 of the function provider entity 22 registers itself with its local network repository entity, having a lower hierarchical level, and this registration is recorded at the respective network repository entity with a higher hierarchical level associated thereto. In particular, in the exemplary configuration of FIG. 10A, instance 22-1 belongs to area A and region 1 having as local network repository entity NRF-1. Thus, instance 22-1 registers with NRF-1, as local network repository entity with lower hierarchical level. This registration is furthermore recorded at network repository entity NRF-3.

In particular, at a step S1, instance 22-1 of the function provider entity 22 sends a registration request to network repository entity 12-1 for registering itself. The registration request can comprise at least an identification of the set, or set ID, allowing the set of instances belonging to function provider entity 22 to be recognized.

In some embodiments, the registration request can further comprise at least an indication that the function provider entity 22 comprises a plurality of instances 22-1, 22-2, 22-3 deployed as a set across the plurality of network repository entities 12-1, 12-2, 12-3 having lower and higher hierarchy levels. This indication is provided by instances of a NFp where the NFp has instances registered in at least two local/regional NRFs, and allows the network repository entity 12-1 to advantageously recognize that further instances are registered across the NRF hierarchy and thus cause the execution of step S2. The indication can be provided in form of a flag.

As a step S2, the network repository entity 12-1 transmits a registration request to the network repository entity with a higher hierarchical level, here network repository entity 12-3. This registration request also comprises the identification of the set.

It will be clear to those skilled in the art that other implementations are possible. For instance, the request indicated at step S2 can be sent by the instance 22-1 to the network repository entity 12-3. In general, step S2 can be implemented in any manner which allows the network repository entity with higher hierarchical level to be informed that an instance has been registered with a network repository entity with a lower hierarchical level.

Thanks to step S2 it is therefore advantageously possible for the network repository entity with a higher hierarchical level to keep track of which instances are registered at network repository entities with a lower hierarchical level.

A step S3, the network repository entity with the higher hierarchical level can store routing information of the instance 22-1 in correspondence with the identification of the set 22. In some embodiments, the routing information can refer to the nrfInfo field, as defined for instance in 3GPP TS 29.510. This information can be used by network repository entity 12-3 to identify which NFs are registered in each local NRF.

Steps S4-S6 correspond to steps S1-S3, with the exception that the registration is performed by instance 22-2. Steps S7-S9 correspond to steps S1-S3, with the exception that the registration is performed by instance 22-3 and that the registration is done with network repository entity 12-2, since instance 22-3 belongs to area B and region 2, for which the network repository entity 12-2 is responsible.

The above steps therefore allow a plurality of instances 22-1 to 22-2, of the same function provider entity 22, spanned across a plurality of network repository entities 12-1 to 12-3 having different hierarchical levels to be registered at their respective network repository entity as well as having a centralized knowledge of those registration at a network repository entity with a higher hierarchical level. Moreover, an indication can be available at the local/regional network repository entities that instances are registered at other local/regional network repository entities. This advantageously allows the subsequent discovery of those other instances.

Steps S1-S9 can be understood as being steps for configuring the wireless communications network. In some embodiments they can be executed once at a configuration phase.

Steps S10-S19, on the other hand, can be understood as being steps for using the configured wireless communications network. In some embodiments they can be executed a plurality of times after the configuration phase.

At step S10, a discovery request for the function provider entity 22 is sent from the function consumer entity 23 to its respective network repository entity. The discovery request might comprise an indication of the network function type for which the discovery is intended, in a known manner. Alternative parameters might be used for identifying the function provider entity 22, in known manners. In the exemplary configuration illustrated in FIG. 10B, the network repository entity responsible for consumer entity 23 is NRF-1. At this stage, the function consumer entity 23 might have no knowledge that the function provider entity 22 is implemented by a plurality of instances.

At steps S11 and S12 the network repository entity 12-1 generally recognizes that the function provider entity 22 comprises the plurality of instances 22-1, 22-2, 22-3 deployed as a set across the plurality of network repository entities 12-1, 12-2, 12-3 having lower and higher hierarchy levels.

This recognition can be achieved in a plurality of manners.

For instance, the network provider entity 12-1 can gather the information that the function provider entity 22 comprises the plurality of instances 22-1, 22-2, 22-3 deployed as a set across the plurality of network repository entities 12-1, 12-2, 12-3 having lower and higher hierarchy levels thanks to the previously mentioned indication that the function provider entity 22 comprises a plurality of instances 22-1, 22-2, 22-3 deployed as a set across the plurality of network repository entities 12-1, 12-2, 12-3 having lower and higher hierarchy levels, sent for instance at step S1. Alternatively, or in addition, the network provider entity 12-1 can gather this information thanks to the identification of the set, stored in association with the registration of the instance 12-1 and acting as indication that the function provider entity 22 comprises a plurality of instances 22-1, 22-2, 22-3 deployed as a set across the plurality of network repository entities 12-1, 12-2, 12-3 having lower and higher hierarchy levels. Further alternatively, or in addition, the network provider entity 12-1 can gather this information by contacting the instance 12-1 and receiving the respective indication or set identification.

In the illustrated embodiment, the recognizing step is implemented by steps S11 and S12.

Step S11 is an identifying step, during which the at least one of the plurality of instances 22-1, 22-2, 22-3, which has registered with the network repository entity 12-1, is identified. This can be performed in a known manner for instance, based on the network type indicated in the discovery message at step S10. In the illustrated exemplary embodiment, instances 22-1 and 22-2 can be detected by the network repository entity 12-1 as a result of the discovery request at step S10. In the following description reference will be made to instance 22-1, it will however be clear to those skilled in the art that the same applies to instance 22-2.

Once instance 22-1 is identified, a retrieving step S12 retrieves the identification of the set based on the instance 22-1 identified at the identifying step. This can be implemented in various manners. In some embodiments, the identification of the set can be registered at the network repository entity 12-1 be the previous registration of the instance 22-1.

In general, steps S11 and S12 allow the network repository entity 12-1 to obtain the newly introduced indication that the function provider entity 22 comprises a plurality of instances 22-1, 22-2, 22-3 deployed as a set across the plurality of network repository entities 12-1, 12-2, 12-3 as well as the identification of the set to which the instance 22-1 belongs. The indication allows network repository entity 12-1 to know that further instances, such as instance 22-3 in the illustrated exemplary embodiment, might be registered with other network repository entities, such as network repository entity 12-2. Those can be retrieved by using the identification of the set as will be described below.

At steps S13-S18, if the network repository entity 12-1 identified the indication, that the function provider entity 22 comprises a plurality of instances 22-1, 22-2, 22-3 deployed as a set across the plurality of network repository entities 12-1, 12-2, 12-3, the network repository entity 12-1 therefore generally contacts a network repository entity 12-3 having a higher hierarchical level to gather information on which instances, corresponding to the identification of the set, are registered elsewhere in the wireless communications network. It will be clear to those skilled in the art that these can be implemented in a plurality of manners.

In the exemplary embodiment illustrated in FIG. 10B, at a step S13 the network repository entity 12-1 transmits a discovery request for the function provider entity 22 to the network repository entity 12-3, having a higher hierarchical level. This discovery request comprises the identification of the set so as to allow the network repository entity 12-3 to identify further instances of the function provider entity 22, directly and/or by forwarding the discovery request to one or more other repository entities in the wireless communications network.

That is, the network repository entity 12-3, having a higher hierarchical level might answer the discovery request directly, by providing the network profile of the one or more instances corresponding to the identification of the set. This could happen, for instance, if the network repository entity 12-3 is implementing a local/regional NRF functionality as well, and the one or more instances corresponding to the identification of the set are registered locally with the network repository entity 12-3. Alternatively, or in addition, this could happen if the network repository entity 12-3 has previously cached results from other local NRFs.

In some embodiments, the network repository entity 12-3 provides, at a step S17, the network profile of all of the instances corresponding to the identification of the set, thus also including instances 22-1 and 22-2, registered with network repository entity 12-1, from which the discovery request was received. This provides the advantage that network repository entity 12-1 is informed in a single step of the network profile and can directly forward this information as a response to the discovery request of step S10.

In preferred embodiments, however, the network repository entity 12-3 could provide, at the step S17, the network profile of all instances corresponding to the identification of the set, except for those registered with the network repository entity 12-1, from which the discovery request was received.

As indicated above, in both cases, the network repository entity 12-3 can retrieve information on the one or more instances 22-1 to 22-3 directly from information stored at the network repository entity 12-3 as illustrated in the exemplary embodiment of FIG. 10B, the network repository entity 12-3 can identify the instances corresponding to the identification of the set and then proceed to contact the respective network repository entity for retrieving information on the respective instance, through steps S14, S15 and S16. This is a particularly advantageous approach since it allows the discovery of all instances throughout the hierarchy of network repository entities via a request to the network higher level repository entity 12-3.

In implementations in which the network repository entity 12-3 forwards the discovery request, as for instance indicated in the illustrated embodiment, it can be advantageous to provide a step S14 which identifies which network repository entities have registered an instance corresponding to the identification of the set, so as to avoid sending a discovery request to network repository entities which have no registered instances. This is particularly advantageous as it allows to identify the local/regional NRFs based on the identification of the set provided in the previous registration.

In the illustrated embodiment, at a step S15 a discovery request comprising the identification of the set is therefore transmitted to one or more repository entities which have been identified as registering instances associated with the identification of the set, such as network repository entity 12-2.

In the illustrated embodiment, at a step S16 the network repository entity which received the request at step S15 sends a discovery response comprising a network profile of the one or more instances 22-1 registered with it. In embodiments where the network repository entity has a plurality of instances registered with it, such as for instance network repository entity 12-1 and instances 22-1 and 22-2, the network repository entity returns information concerning all of the instances registered with it.

In the illustrated embodiment, the network repository entity 12-3 only needs to contact network repository entity 12-2, as this is the only network repository entity at which instance corresponding to the identification of the set have been registered, in addition to network repository entity 12-1 from which the discovery request has been received. Thus steps S15 and S16 are only illustrated as being executed once. It will however be clear that they can be executed for any network repository entity at which instances are registered, as previously discussed. In this case, a no-illustrated step can combine the responses received as steps S16.

At a steps S17, the information on the instances retrieved by the network repository entity 12-3, the network function profiles of the instances, also known as NF profile, can be sent to the network repository entity 12-1 as a response to the step S10.

In the illustrated embodiment, the information sent at step S17 is limited to those instances not registered with network repository entity 12-1, but registered with other network repository entities, so that a combination step S18, combining the information on the locally registered instances, such as 22-1 and 22-2 with the information on the instances registered as other network repository entities, such as 22-3, can be executed.

Finally, at a step S19, information on all instances 22-1 to 22-3 of the function provider entity 22 can be provided to the function consumer entity 23. It will be clear to those skilled in the art that in this context, all instances refer to all the instances discovered in the different steps. There may be more instances registered not subject to be returned in the discovery for different reasons, such as not availability, not matching searching criteria, etc.

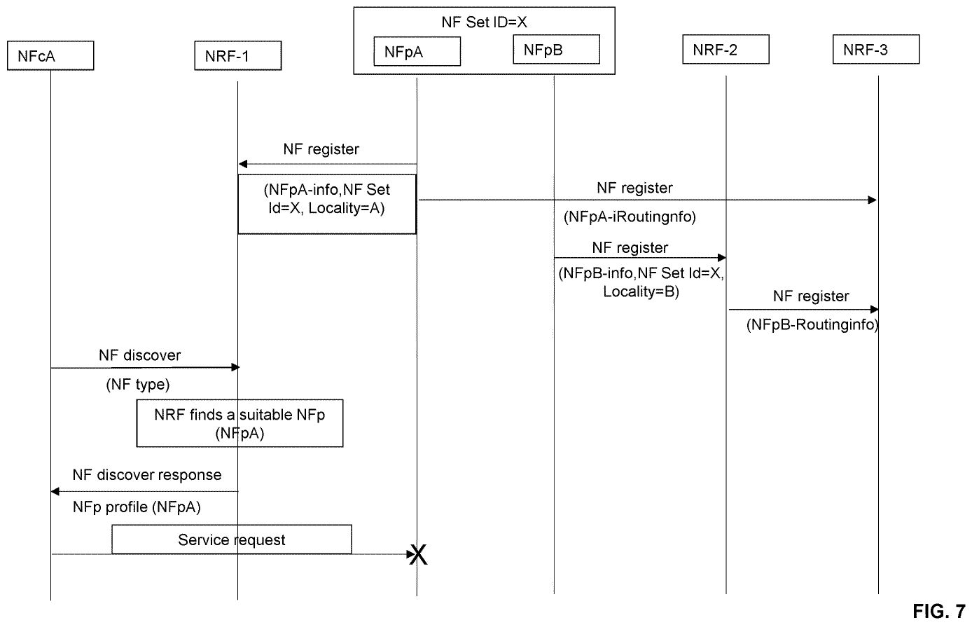

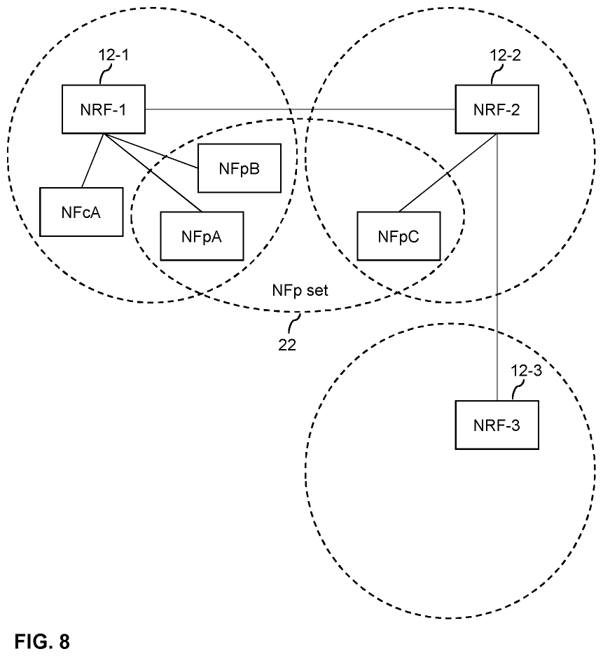

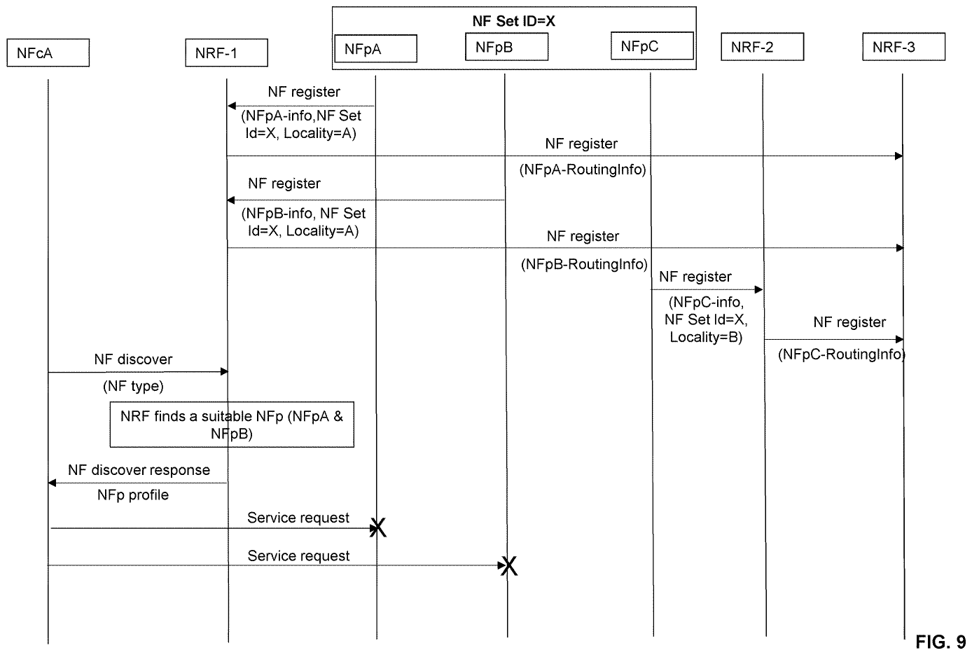

This advantageously allows the shortcomings of the prior art to be avoided, since the function consumer entity 23 can be made aware of instances 22-1, 22-2 and 22-3 of the function provider entity 22 registered at various NRF, and not only at the NRF which received the original request from the NFc. Thus, even in the presence of issues such as those discussed in relation with FIGS. 7 and 9, the function consumer entity 23 can make use of any of the instances 22-1, 22-2 and 22-3 of the function provider entity 22. For instance, in case of a local failure of NFpA, function consumer entity 23 can revert to any of NFpB or NFpC. Similarly, in case of an area failure of area A, resulting in the impossibility to use NFpA and NFpB, function consumer entity 23 can still revert to NFpC.

It has therefore be described how an exemplary embodiment of the invention can operate. In the following, the various steps S1-S19 will be further described in pseudo-code terminology. It will be understood that any combination of the definitions provided above, and below, for any of the steps S1-S19 is possible.

In the pseudo-code indicated below, the identification of the set is indicated as Set ID. The indication that the function provider entity 22 comprises a plurality of instances 22-1, 22-2, 22-deployed as a set across the plurality of network repository entities 12-1, 12-2, 12-3 having lower and higher hierarchy levels is given by the flag NF Set spanned in NRF hierarchy.
Step S1: NF register (NFpA-info, NF Set Id=X, Locality=A, NF Set spanned in NRF hierarchy)
Step S2: NF register (RoutingInfo-NFpA, servedNFSetld=X)
Step S3: NF Store (RoutingInfo-NFpA, servedNFSetId=X)
Step S4: NF register (NFpB-info, NF Set Id=X, Locality=A, NF Set spanned in NRF hierarchy)
Step S5: NF register (RoutingInfo-NFpB, servedNFSetld=X)
Step S6: NF Store (RoutingInfo-NFpB, servedNFSetId=X)
Step S7: NF register (NFpC-info, NF Set Id=X, Locality=B, NF Set spanned in NRF hierarchy)
Step S8: NF register (RoutingInfo-NFpC, servedNFSetid=X)
Step S9: NF Store (RoutingInfo-NFpC, servedNFSetId=X)
Step S10: NF discover (NF Type, or other known parameters)
Step S11: NRF finds a suitable NFp (NFpA & NFpB in the illustrated embodiment): Suitable NFps indicate they belong to a Set that is spanned in an NRF hierarchy
Step S12: retrieving Set ID from suitable NFps
Step S13: NF discover (NF Set Id=X)
Step S14: NRF identification (NF Set Id=X)
Step S15: NF discover (NF Set Id=X)
Step S16: NF discover response (NFp profiles, such as NFpC in the illustrated embodiment)
Step S17: NF discover response (NFp profiles, such as NFpC in the illustrated embodiment)
Step S18: NFp profiles combination
Step S19): NF discover response (NFp profiles, such as NFpA, NFpB and NFpC in the illustrated embodiment)

Further specific embodiments of the invention will thus be described with reference to FIGS. 10A, 10B and 11-18. It will be understood that the optional and alternative definitions discussed above for FIGS. 10A, 10B also apply to any of the embodiments described in the following with reference to FIGS. 11-18.

As can be seen in FIG. 11, an embodiment of the invention can relate to a method 300 for operating a network repository entity in a wireless communications network. The network repository entity can be understood as being one with a lower hierarchical level, such as any of 12-1, 12-2, in the exemplary configuration of FIGS. 10A and 10B. The network can comprise a function provider entity 22 and at least one function consumer entity 23, capable of consuming services from the function provider entity 22. In particular, the function provider entity 22 comprises a plurality of instances 22-1, 22-2, 22-3 deployed as a set across a plurality of network repository entities 12-1, 12-2, 12-3 having lower and higher hierarchy levels. The set can be identified by the set ID, which can also be indicated as the identification of the set throughout the description, as previously described.

The method 300 comprises a step S1 of receiving, from at least one of the plurality of instances 22-1, 22-2, 22-3, a registration request comprising an identification of the set. In the exemplary configuration of FIGS. 10A and 10B, this is instance 22-1 for step S1. It is understood that the registration request can comprise further elements such as any of information on the instance 22-1, an indication on a locality in which the instance 22-1 is operating, and an indication that the function provider entity 22 comprises a plurality of instances deployed as a set across the plurality of network repository entities having lower and higher hierarchy levels, also indicating that the plurality of network repository entities have a hierarchical configuration.

The method 300 further comprises a step S2 of transmitting, to a further network repository entity, a further registration request comprising the identification of the set. In the exemplary configuration of FIG. 10A, the network repository entity can be the network repository entity 12-3. The further network repository entity is a network repository entity having a higher hierarchical level than the network repository entity 12-1.

Thanks to this approach, the network repository entity 12-1 can thus inform the further network repository entity 12-3 that the instance 22-1 has been registered with the network repository entity 12-1. This allows subsequent discovery requests for the function provider entity 22 to the further network repository entity 12-3 to be answered.

In particular, the further network repository entity 12-3 has a higher hierarchy level than the network repository entity 12-1. Several manners are known for network repository entity 12-1 to know to what higher level entity the message at step S2 has to be transmitted. This can be obtained by a previous configuration of the network repository entity 12-1, storing routing information for the further network repository entity 12-3 as the network repository entity to which the message of step S2 has to be sent. It will be clear to those skilled in the art that several manners are possible for configuring the network repository entity 12-1 accordingly.

In some embodiments, the registration request can comprise an indication that the function provider entity 22 comprises a plurality of instances 22-1, 22-2, 22-3 deployed as a set across the plurality of network repository entities 12-1, 12-2, 12-3 having lower and higher hierarchy levels. This allows the network repository entity 12-1 to be explicitly informed that the set is deployed across several network repository entities.

In some embodiments, the at least of the plurality of instances 22-1, 22-2, 22-3 from which the registration request is received at step S1 is configured to register itself with the network repository entity 12-1 transmitting the registration request. That is, the instance 22-1 which is registering itself can do so with its own local/regional network repository entity, as usual. However, the new indication described above, in the registration request, indicates that other instances are registered with different network repository entities having lower and higher hierarchy levels.

In some embodiments a local/regional network repository entity can also have the higher hierarchical level. That is, one network repository entity can act as entity with lower and higher hierarchical level. In this case, the step S2 can be avoided at this specific network repository entity and the method can proceed to step S3. This allows using the network repository entity with the higher hierarchical level also as a local/regional network repository entity. Said otherwise, this a local/regional network repository entity to also act as a network repository entity with the higher hierarchical level. It will be clear that the invention is not limited thereto and, in some embodiments, the network repository entity with the higher hierarchical level can only act as such, and not also as network repository entity with a lower hierarchical level.

The plurality of network repository entities 12-1, 12-2, 12-3 can be configured to operate in a hierarchical manner, as described. That is, the plurality of network repository entities 12-1, 12-2, 12-3 can comprise at least two network repository entities 12-1, 12-2 with a lower level, and at least one network repository entity 12-3 with a higher level, which is common to the at least two network repository entities 12-1, 12-2 with the lower level. While the embodiments above describe a situation with two hierarchical level, the invention is not limited thereto and a plurality of hierarchical levels might be implemented. In this case, the step S2 could be repeated, from one hierarchical level to the next higher one, preferably until reaching the highest hierarchical level.

The network repository entities can thus be configured so that information on the registration of at least one instance at a lower hierarchical level, at step S1, is transmitted to a higher hierarchical level, at step S2, which stores this information at step S3. This allows the hierarchical structure of the network repository entities to be configured such that knowledge of the deployment of the instances 22-1 to 22-3 can be retrieved by any network repository entity by sending a discovery request to a network repository entity with a higher hierarchical level.

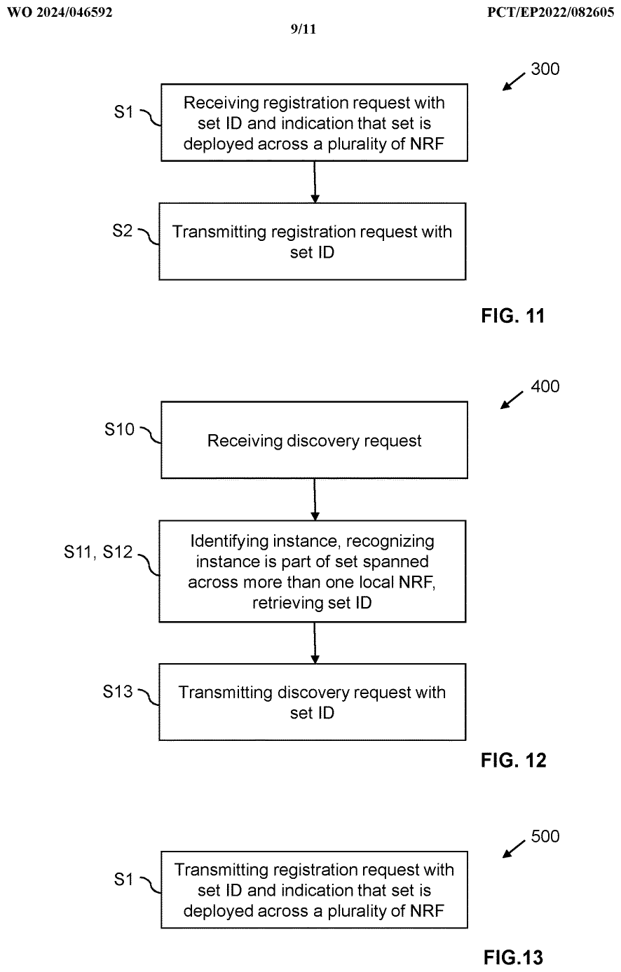

As can be seen in FIG. 12, a further embodiment of the invention can relate to a method 400 for operating a network repository entity in a wireless communications network. Preferably, the network has been configured as described above, in particular by applying method 300. The network repository entity which is operated by method 400 can have a lower hierarchical level, such as 12-1 and 12-2, in which case the method operates as described below. Alternatively, on in addition, the network repository entity which is operated by method 400 can have a higher hierarchical level, such as 12-3, in which case the method operates without step S13, as the discovery request can be executed locally.

The method 400 comprises a step S10 of receiving, from the function consumer entity 23, a discovery request for the function provider entity 22. The discovery request can comprise information allowing identification of the function provider entity 22, such as the network function type corresponding to the function provider entity 22, or other known parameters. This allows the network repository entity to identify the function provider entity 22 in a known manner.

The method 400 comprises a further step S11, S12 of recognizing that the function provider entity 22 comprises the plurality of instances 22-1, 22-2, 22-3 deployed as a set across the plurality of network repository entities 12-1, 12-2, 12-3 having lower and higher hierarchy levels. The set, as previously described, is identified by an identification, set ID.

The recognizing step can be generally implemented by the network repository entity retrieving information concerning the at least one instance of the function provider entity registered with it, and, based on this information, recognizing that the function provider entity has a plurality of instances. The network repository entity can obtain this information by the indication that the function provider entity comprises a plurality of instances deployed as a set across the plurality of network repository entities having lower and higher hierarchy levels, which can have been provided by the instance upon registration.

In general, the recognizing therefore allows the local network repository entity to recognize that further instances of the function provider entity 22 are available and are registered at different network repository entities. Thanks to this information, the network repository entity can proceed to send a discovery request to a network repository entity with a higher hierarchical level, which can have knowledge of where, in the hierarchy of network repository entities, the other instances are registered.

The method 400 further comprises a step S13 of transmitting, to a further network repository entity, such as 12-3, a further discovery request for the function provider entity 22, the further discovery request comprising the identification of the set. It will be clear that the further discovery request can also comprise further elements such as routing information, or other information or selecting criteria, of the instance registered with the network repository entity. In general, the step S13 contains information which allows the further network repository entity, or the network repository entity with a higher hierarchical level, to know in which local/regional NRF the instance has been registered.

In embodiments where the method 400 is executed by a network repository entity having a higher hierarchical level, such as 12-3, then step S13 can be avoided, since the network repository entity is already the one with the higher hierarchical level and already has all the knowledge necessary for answering a discovery request for the instance which registered with it. Alternatively, or in addition, the information which would have been sent with step S13 can be recorded locally.

In some embodiments, the further network repository entity 12-3 has a higher hierarchy level than the network repository entity 12-1, 12-2. That is, the further network repository entity to which method 400 sends a discovery request at step S13 can have a hierarchy level higher than the network repository entity sending the discovery request. In the presence of more than two hierarchical level step S13 can be executed a plurality of times, preferably until reaching the highest hierarchical level.

In some embodiments, the method 400 can further comprise a step S17 of receiving, from the further network repository entity 12-3, a discovery response, comprising a profile of the one or more instances 22-1, 22-2, 22-3 not registered with the network repository entity 12-1, 12-2. Preferably, the discovery response indicates all instances not registered with the network repository entity 12-1, 12-2.

In some embodiments, the method 400 can further comprise a step S19 of transmitting, to the function consumer entity 23, a further discovery response comprising a profile of the one or more instances 22-1, 22-2, 22-3 not registered with the network repository entity 12-1, 12-2. In this manner, the discovery request received at step S10 can be answered. The content of the further discovery response can be based on data received from the further network repository entity 12-3, and/or on data locally available at the network repository entity 12-1, 12-1. In particular, in some embodiments, the further discovery response can further comprise the one or more instances 22-1, 22-2, 22-3 registered with the network repository entity 12-1, 12-2.

In some embodiments, the step of recognizing S11, S12 can comprise a step S11 of identifying at least one of the plurality of instances 22-1, 22-2, 22-3 registered with the network repository entity 12-1, 12-2. This identification can be generally based on the registration data of the instances 22-1, 22-2, 22-3 registered with the network repository entity 12-1, 12-2. In general, known manners are available for identifying the instances based on the data contained in the discovery request of step S10. Step S11 can also recognize that the instance belongs to a set spanned in the NRF hierarchy, as this was indicated during registration. The step of recognizing S11, S12 can further comprise a step S12 of retrieving the identification of the set based on the at least one instance 22-1, 22-2, 22-3 identified at the identifying step. That is, once one or more instances registered locally have been identified, the corresponding Set ID can be retrieved. This can be performed locally, at the network repository entity 12-1, 12-2 and/or by an appropriate request to the one or more instance. Once the Set ID is retrieved, it can be used in a discovery request to the network repository entity with a higher hierarchical level 12-3 to identify instances which are registered with other network repository entities.

As can be seen in FIG. 13, a further embodiment of the invention can relate to a method 500 for operating an instance 22-1, 22-2 of a function provider entity 22 in a wireless communications network. The wireless communication network can be the same as previously described.

The method 500 comprises a step S1 of transmitting, to the network repository entity 12-1, 12-2, a registration request comprising an identification of the set. That is, the instance can register with its local/regional network repository entity and provide the Set ID as parameter. This, as previously described, can be stored at the network repository entity and can be later used for identification of other instances. In some embodiments, as previously described, the registration request can further comprise an indication that the function provider entity 22 comprises a plurality of instances 22-1, 22-2, 22-3 deployed as a set across the plurality of network repository entities 12-1, 12-2, 12-3 having lower and higher hierarchy levels.

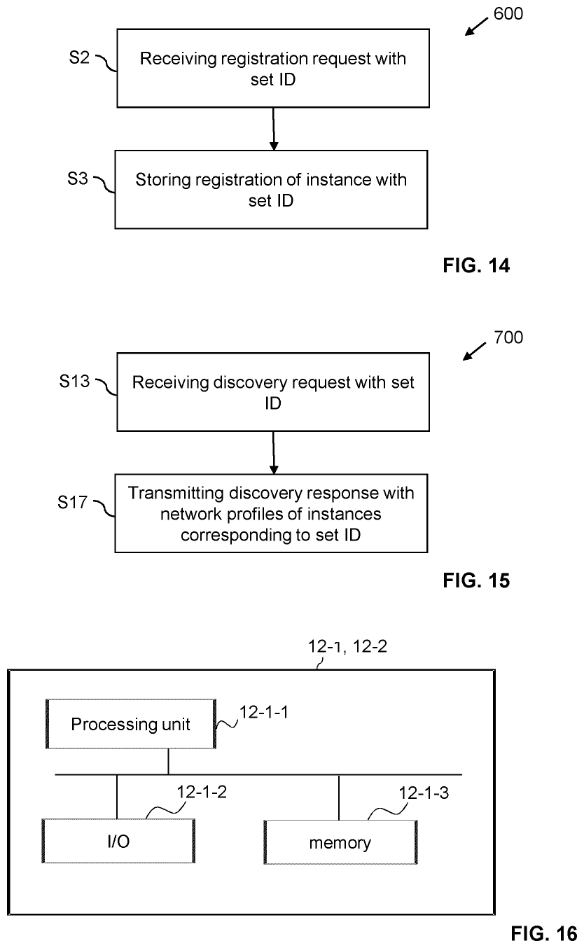

As can be seen in FIG. 14, a further embodiment of the invention can relate to a method 600 for operating a network repository entity 12-3 in a wireless communications network. The wireless communication network can be the same as previously described.

The method 600 comprises a step S2 of receiving from a further network repository entity 12-1, a registration request comprising the identification of the set. The considerations previously made for step S2, in particular with reference to method 300, apply also to method 600.

The method 600 further comprises a step S3 of storing routing information of the at least one 22-1, 22-2 of the plurality of instances 22-1, 22-2, 22-3 in correspondence with the identification of the set. That is, information concerning the registration of the instance can be stored together with the Set ID. This allows a subsequent identification of the relevant information, by using the Set ID as search key.

As can be seen in FIG. 15, a further embodiment of the invention can relate to a method 700 for operating a network repository entity 12-3 in a wireless communications network. The wireless communication network can be the same as previously described.

The method 700 comprises a step S13 of receiving from a further network repository entity 12-1, 12-2, a discovery request for the function provider entity 22 comprising an identification of the set. The considerations previously made for step S13, in particular with reference to method 400, apply also to method 700.

The method 700 further comprises a step S17 of transmitting, to the further network repository entity 12-1, 12-2, a discovery response comprising a profile of the one or more instances 22-1, 22-2, 22-3 not registered with the further network repository entity 12-1, 12-2. The indication can generally comprise information which allows the function consumer entity 23, and/or the network repository entity 12-1, 12-2, to contact the plurality of instances 22-1, 22-2, 22-3 not registered with the further network repository entity 12-1, 12-2. In preferred embodiments, the information can be any of the routing information of the instances, and/or the network function profile or the instances, or similar.

Several manners are known, for the network repository entity 12-3, to retrieve the information allowing identification of the instances based on the Set ID. This can in particular be done locally at the network repository entity 12-3, if the information is available locally. The relevant information could be, for instance, transmitted with step S2. Alternatively, on in addition, this can be achieved by contacting the instances directly based on the information received at step S2. Still alternatively, or in addition, this can be achieved by contacting the network repository entity with a lower hierarchy level, at which the instances are registered, as illustrated in the exemplary embodiment of FIG. 10B.

In the latter case, in some embodiments, the method 700 can therefore further comprise a step transmitting S15, to one or more further network repository entity 12-2, a further discovery request comprising the identification of the set, and a step S16 of receiving, from the one or more further network repository entity 12-2, a discovery response comprising a profile of the at least one of the plurality of instances 22-1, 22-2, 22-3 registered with the one or more further network repository entity 12-1. In this manner, the amount of information which need to be stored at the network repository entity 12-3 can be reduced.

In some embodiments, the one or more further network repository entity 12-2 can comprise all network repository entities 12-1, 12-2 with a lower hierarchy level than the network repository entity 12-3. That is, the message transmitted at step S15 can be sent to all network repository entities 12-1, 12-2 with a lower hierarchy level. This can further simplify operation of the network repository entity 12-2, as well as potentially reduce the amount of data which needs to be stored at the network repository entity 12-3.

Alternatively, or in addition, in some embodiments the one or more further network repository entity 12-2 can comprise all network repository entities 12-1, 12-2 with a lower hierarchy level than the network repository entity 12-3, except for the further network repository entity 12-1, 12-2. This advantageously avoids sending the request of step S15 to the network repository entity which originated the request of step S13, so that the amount of data traffic in the network is reduced.

In some embodiments, as illustrated in FIG. 10B, instead of indiscriminately contacting network repository entities with a lower hierarchy level, the method 700 can further comprise a step S14 of identifying, based on the identification of the set, the one or more further network repository entity 12-2 at which the at least one of the plurality of instances 22-1, 22-2, 22-3 not registered with the further network repository entity 12-1, 12-2 is registered. That is, the network repository entity 12-3 can identify which of the network repository entities has reported registration of one or more instances at step S2, S5 or S8. In the exemplary configuration of FIGS. 10A and 10B this would result in the identification of network repository entity 12-1 and 12-2. Optionally, from this result, the network repository entity 12-3 can exclude the network repository entity from which the discovery request of step S13 has been received. The network repository entities which have been identified at step S14 can then be selected for transmitting a discovery request at step S15, as illustrated in FIG. 10B.

In some embodiments, the method 700 can further comprise a step S17 of transmitting, to the further network repository entity 12-1, a further discovery response as a response to the discovery request of step S13, comprising a profile of the one or more instances 22-1, 22-2, 22-3 not registered with the further network repository entity 12-1, 12-2.

In this manner, it has been described how the lower hierarchy level network repository entity 12-1, 12-2 can retrieve information on instances from the higher hierarchy level network repository entity 12-3. This information can be, if needed, combined with the information on the locally registered instances, already available at the lower hierarchy level network repository entity 12-1, 12-2, and then forwarded to the function consumer entity 23.

Although embodiments of the invention have been described in terms of methods, and corresponding method steps, it will be clear that corresponding embodiments of the invention can also be implemented as devices, or software products. In general, a software can comprise instructions configured to cause a processor to implement any of the steps described above. Similarly, a device can be implemented comprising a memory and a processor, where the memory comprises instructions configured to cause the processor to implement any of the steps described above.

More specifically, as visible in FIG. 16, an embodiment of the invention can relate to a network repository entity 12-1, 12-2 operable in a wireless communications network, the wireless communications network comprising a function provider entity 22 and at least one function consumer entity 23, capable of consuming services from the function provider entity 22. In particular, the function provider entity 22 can comprise a plurality of instances 22-1, 22-2, 22-3 deployed as a set across a plurality of network repository entities 12-1, 12-2, 12-3 having lower and higher hierarchy levels. The network repository entity 12-1, 12-2 comprises a processing unit 12-1-1, and a memory 12-1-3. The memory 12-1-3 comprises instructions configured to cause the processing unit 12-1-1 to carry out a method comprising a step of receiving, similar to steps S1, S4, S7, described above, from at least one of the plurality of instances 22-1, 22-2, 22-3, a registration request comprising an identification of the set. The memory 12-1-3 further comprises instructions configured to cause the processing unit 12-1-1 to carry out a step of transmitting, similar to steps S2, S5, S8 described above, to a further network repository entity 12-3, a further registration request comprising the identification of the set.

Alternatively or in addition, the memory 12-1-3 can comprise instructions configured to cause the processing unit 12-1-1 to carry out a method comprising a step of receiving, similar to step S10 described above, from the function consumer entity 23, a discovery request for the function provider entity 22. The memory 12-1-3 further comprises instructions configured to cause the processing unit 12-1-1 to carry out a step of recognizing, similar to steps S11, S12 described above, that the function provider entity 22 comprises the plurality of instances 22-1, 22-2, 22-3 deployed as a set across the plurality of network repository entities 12-1, 12-2, 12-3 having lower and higher hierarchy levels, wherein the set is identified by an identification. The memory 12-1-3 further comprises instructions configured to cause the processing unit 12-1-1 to carry out a step of transmitting, similar to step S13 described above, to a further network repository entity 12-3, a further discovery request for the function provider entity 22, the further discovery request comprising the identification of the set.

In some embodiments, the memory 12-1-3 can further comprise instructions configured to cause the processing unit 12-1-1 to further carry out any of the steps described above, in particular those executed by any of network repository entity 12-1 or 12-2.

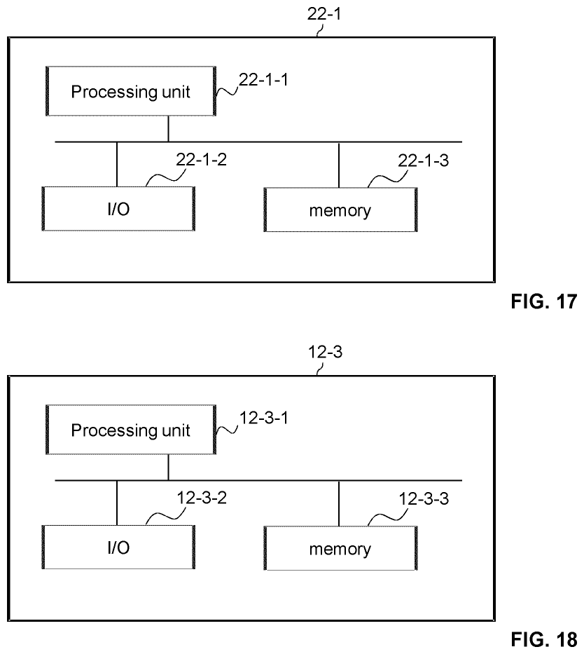

Moreover, as visible in FIG. 17 an embodiment of the invention can relate to an instance 22-1, 22-2 of a function provider entity 22 operable in a wireless communications network, the wireless communications network comprising the function provider entity 22 and at least one function consumer entity 23, capable of consuming services from the function provider entity 22. In particular, the function provider entity 22 comprises a plurality of instances 22-1, 22-2, 22-3 deployed as a set across a plurality of network repository entities 12-1, 12-2, 12-3 having lower and higher hierarchy levels. The instance 22-1, 22-2 comprises a processing unit 22-1-1, and a memory 22-1-3. The memory 22-1-3 comprises instructions configured to cause the processing unit 22-1-1 to carry out a method comprising a step of transmitting, similar to steps S1, S4, S7 described above, to the network repository entity 12-1, 12-2, a registration request comprising an identification of the set.

Moreover, as visible in FIG. 18 an embodiment of the invention can relate to a network repository entity 12-3 operable in a wireless communications network, the wireless communications network comprising a function provider entity 22 and at least one function consumer entity 23, capable of consuming services from the function provider entity 22. In particular, the function provider entity 22 comprises a plurality of instances 22-1, 22-2, 22-3 deployed as a set across a plurality of network repository entities 12-1, 12-2, 12-3 having lower and higher hierarchy levels. The network repository entity 12-3 comprises a processing unit 12-3-1, and a memory 12-3-3. The memory 12-3-3 comprises instructions configured to cause the processing unit 12-3-1 to carry out a method comprising a step of receiving, similar to step S2, S5, S8 described above, from a further network repository entity 12-1, 12-2, a registration request comprising the identification of the set. The memory 12-3-3 further comprises instructions configured to cause the processing unit 12-3-1 to execute a step of storing, similar to steps S3, S6, S9 described above, routing information of the at least one 22-1, 22-2 of the plurality of instances 22-1, 22-2, 22-3 in correspondence with the identification of the set.

Alternatively or in addition, the memory 12-3-3, can comprise instructions configured to cause the processing unit 12-3-1 to carry out a method comprising a step of receiving, similar to step S13 described above, from a further network repository entity 12-1, 12-2, a discovery request for the function provider entity 22 comprising an identification of the set. The memory 12-3-3, can further comprise instructions configured to cause the processing unit 12-3-1 to carry out a step of transmitting, similar to step S17 described above, to the further network repository entity 12-1, 12-2, a discovery response comprising a profile of the one or more instances 22-1, 22-2, 22-3 not registered with the further network repository entity 12-1, 12-2.

In some embodiments, the memory 12-3-3 can further comprise instructions configured to cause the processing unit 12-3-1 to further carry out any of the steps described above, in particular those executed by network repository entity 12-3.

It has thus been described how the invention can allow information of the registration of instances of a function provider entity 22 to be organized in a plurality of network repository entities 12-1, 12-2 and 12-3 having a hierarchical configuration. By allowing this knowledge to be accessible to all network repository entities, through a hierarchical configuration defining which network repository entities should be directing discovery requests and which network repository entities should be responding them, any network repository entity can access this information and respond accordingly to a discovery request. In this manner, a function consumer entity 23 can obtain information on all instances of the function provider entity 22 by directing a corresponding discovery request to any network repository entity in the network.

1. A method for operating a first network repository entity in a wireless communications network, the wireless communications network comprising a function provider entity and at least one function consumer entity, configured to consume services from the function provider entity, the function provider entity comprising a plurality of instances deployed as a set across a plurality of network repository entities having lower and higher hierarchy levels, the method comprising:
receiving, from at least one of the plurality of instances, a registration request comprising an identification of the set and an indication that the function provider entity comprises a plurality of instances deployed as a set across the plurality of network repository entities having lower and higher hierarchy levels; and
transmitting, to a second network repository entity with a higher hierarchy level, a second registration request comprising the identification of the set.

2. The method according to claim 1, wherein the plurality of network repository entities comprise at least two network repository entities with a lower hierarchy level, and at least the second network repository entity, wherein the network repository entity belongs to the at least two network repository entities with the lower hierarchy level, and wherein the second network repository entity has a higher hierarchy level than the at least two network repository entities and is common to the at least two network repository entities.

3. The method according to claim 2, wherein at least a second instance of the plurality of instances is configured to be registered in one of the network repository entities with the lower hierarchy level other than the network repository entity.

4.-10. (canceled)

11. A method for operating a second network repository entity in a wireless communications network, the wireless communications network comprising a function provider entity and at least one function consumer entity, configured to consume services from the function provider entity, the function provider entity comprising a plurality of instances deployed as a set across a plurality of network repository entities having lower and higher hierarchy levels, the method:
receiving, from a first network repository entity, a discovery request for the function provider entity comprising an identification of the set;
transmitting, to the first network repository entity, a discovery response comprising a profile of the one or more instances not registered with the second network repository entity;
transmitting, to one or more third network repository entity, a second discovery request comprising the identification of the set;
receiving, from the one or more third network repository entity, a discovery response comprising a profile of the one or more instances registered with the one or more third network repository entity; and
the one or more third network repository entity comprising all network repository entities with a lower hierarchy level than the first network repository entity.

12. The method according to claim 11, wherein the plurality of network repository entities comprise at least two network repository entities with a lower hierarchy level, and at least the second network repository entity, wherein the second network repository entity belongs to the at least two network repository entities with the lower hierarchy level, and wherein the second network repository entity has a higher hierarchy level than the at least two network repository entities and is common to the at least two network repository entities.

13. (canceled)

14. (canceled)

15. The method according to claim 11, wherein each of the one or more third network repository entity is a local and/or regional network repository entity.

16. The method according to claim 11, wherein the one or more third network repository entity comprise all network repository entities with a lower hierarchy level than the network repository entity, except for the first network repository entity.

17. The method according to claim 11, further comprising identifying, based on the identification of the set, the one or more third network repository entity at which the at least one of the plurality of instances of the set not registered with the first network repository entity is registered.

18. The method according to claim 17, further comprising transmitting, to the second network repository entity, a second discovery response comprising a profile of the one or more instances identified with the identifying step.

19. A first network repository entity operable in a wireless communications network, the wireless communications network comprising a function provider entity and at least one function consumer entity, configured to consume services from the function provider entity, the function provider entity comprising a plurality of instances deployed as a set across a plurality of network repository entities having lower and higher hierarchy levels, the network repository entity comprising a processing unit, and a memory, the memory comprising instructions configured to cause the processing unit to:
receive, from at least one of the plurality of instances, a registration request comprising an identification of the set and an indication that the function provider entity comprises a plurality of instances deployed as a set across the plurality of network repository entities having lower and higher hierarchy levels; and
transmit to a second network repository entity with a higher hierarchy level, a second registration request comprising the identification of the set.

20. The network repository entity according to claim 19, wherein the plurality of network repository entities comprise at least two network repository entities with a lower hierarchy level, and at least the second network repository entity, wherein the network repository entity belongs to the at least two network repository entities with the lower hierarchy level, and wherein the second network repository entity has a higher hierarchy level than the at least two network repository entities and is common to the at least two network repository entities.

21.-23. (canceled)

24. A second network repository entity operable in a wireless communications network, the wireless communications network comprising a function provider entity and at least one function consumer entity, configured to consume services from the function provider entity, wherein the function provider entity comprising a plurality of instances deployed as a set across a plurality of network repository entities having lower and higher hierarchy levels, the network repository entity comprising a processing unit and a memory, the memory comprising instructions configured to cause the processing unit to:
receive, from a first network repository entity, a registration request comprising the identification of the set;
store routing information of the at least one of the plurality of instances in correspondence with the identification of the set;
transmit, to one or more third network repository entity, a second discovery request comprising the identification of the set;
receive, from the one or more third network repository entity, a discovery response comprising a profile of the one or more instances registered with the one or more third network repository entity; and
the one or more third network repository entity comprising all network repository entities with a lower hierarchy level than the network repository entity.

25. (canceled)

26. (canceled)

27. The method according to claim 15, further comprising identifying, based on the identification of the set, the one or more third network repository entity at which the at least one of the plurality of instances of the set not registered with the first network repository entity is registered.

28. The method according to claim 16, further comprising identifying, based on the identification of the set, the one or more third network repository entity at which the at least one of the plurality of instances of the set not registered with the first network repository entity is registered.
